(19) United States
(12) Patent Application Publication
(10) Pub. No.: US 2011/0057891 A1
(43) Pub. Date: Mar. 10, 2011

(54) WIRELESS POWER DISPLAY DEVICE

(75) Inventors: Sang Won Ham, Downey, CA (US); Julie Xiaoshu Kuang, San Diego, CA (US); David Joseph Vanoni, Carlsbad, CA (US)

(73) Assignee: QUALCOMM INCORPORATED, San Diego, CA (US)

(21) Appl. No.: 12/784,425

(22) Filed: May 20, 2010

Related U.S. Application Data
(60) Provisional application No. 61/241,327, filed on Sep. 10, 2009.
(60) Provisional application No. 61/241,332, filed on Sep. 10, 2009.
(60) Provisional application No. 61/241,335, filed on Sep. 10, 2009.

(51) Int. Cl. G06F 3/041; G06F 3/038

(52) U.S. Cl. 345/173; 345/211

(57) ABSTRACT

Exemplary embodiments are directed to a display device for conveying wireless power. A device may comprise a display surface for placement of one or more chargeable devices and for displaying data associated therewith. The device may further include at least one transmit antenna proximate the display surface for transmitting wireless power within an associated charging region.

This application claims priority under 35 U.S.C. §119(e) to:

U.S. Provisional Patent Application 61/241,327 entitled “WIRELESS POWER ENABLED MULTI-TOUCH TABLE” filed on Sep. 10, 2009, the disclosure of which is hereby incorporated by reference in its entirety;

U.S. Provisional Patent Application 61/241,332 entitled “WIRELESS POWER ENABLED MULTI-TOUCH TABLE” filed on Sep. 10, 2009, the disclosure of which is hereby incorporated by reference in its entirety; and

U.S. Provisional Patent Application 61/241,335 entitled “WIRELESS POWER ENABLED MULTI-TOUCH TABLE” filed on Sep. 10, 2009, the disclosure of which is hereby incorporated by reference in its entirety.

### BACKGROUND

1. Field

The present invention relates generally to wireless power, and more specifically to a display device configured to display data, convey wireless power, and communicate via near-field communication means.

2. Background

Typically, each battery powered device requires its own charger and power source, which is usually an AC power outlet. This becomes unwieldy when many devices need charging.

Approaches are being developed that use over the air power transmission between a transmitter and the device to be charged. These generally fall into two categories. One is based on the coupling of plane wave radiation (also called far-field radiation) between a transmit antenna and receive antenna on the device to be charged which collects the radiated power and rectifies it for charging the battery. Antennas are generally of resonant length in order to improve the coupling efficiency. This approach suffers from the fact that the power coupling falls off quickly with distance between the antennas. So charging over reasonable distances (e.g., >1-2m) becomes difficult. Additionally, since the system radiates plane waves, unintentional radiation can interfere with other systems if not properly controlled through filtering.

Other approaches are based on inductive coupling between a transmit antenna embedded, for example, in a “charging” mat or surface and a receive antenna plus rectifying circuit embedded in the host device to be charged. This approach has the disadvantage that the spacing between transmit and receive antennas must be very close (e.g. mms). Though this approach does have the capability to simultaneously charge multiple devices in the same area, this area is typically small, hence the user must locate the devices to a specific area.

A need exists for a display device configured to display data and having a wireless charging system integrated therein.

### BRIEF DESCRIPTION OF THE DRAWINGS

FIG. 1 shows a simplified block diagram of a wireless power transfer system.

FIG. 2 shows a simplified schematic diagram of a wireless power transfer system.

FIG. 3 illustrates a schematic diagram of a loop antenna for use in exemplary embodiments of the present invention.

FIG. 4 is a simplified block diagram of a transmitter, in accordance with an exemplary embodiment of the present invention.

FIG. 5 is a simplified block diagram of a receiver, in accordance with an exemplary embodiment of the present invention.

FIG. 6 shows a simplified schematic of a portion of transmit circuitry for carrying out messaging between a transmitter and a receiver.

FIG. 7 illustrates a display device, according to an exemplary embodiment of the present invention.

FIG. 8 is another illustration of the display device of FIG. 7.

FIG. 9 illustrates a portion of a display of a display device having an electronic device positioned thereon, according to an exemplary embodiment of the present invention.

FIG. 10 illustrates a portion of a display of a display device having an electronic device positioned thereon and a plurality of display items, in accordance with an exemplary embodiment of the present invention.

FIG. 11 is another illustration of a portion of a display of a display device having an electronic device positioned thereon and a plurality of display items, according to an exemplary embodiment of the present invention.

FIG. 12 depicts a portion of a display of a display device having plurality of items displayed thereon, in accordance with an exemplary embodiment of the present invention.

FIG. 13 depicts a portion of a display of a display device, according to an exemplary embodiment of the present invention.

FIG. 14 illustrates a portion of a display of a display device having plurality of items displayed thereon, in accordance with an exemplary embodiment of the present invention.

FIG. 15 illustrates a plate positioned on a surface of a display device, according to an exemplary embodiment of the present invention.

FIG. 16 illustrates a cup positioned on a surface of a display device, in accordance with an exemplary embodiment of the present invention.

FIG. 17 is a flowchart illustrating a method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The words “wireless power” is used herein to mean any form of energy associated with electric fields, magnetic fields, electromagnetic fields, or otherwise that is transmitted between from a transmitter to a receiver without the use of physical electromagnetic conductors.

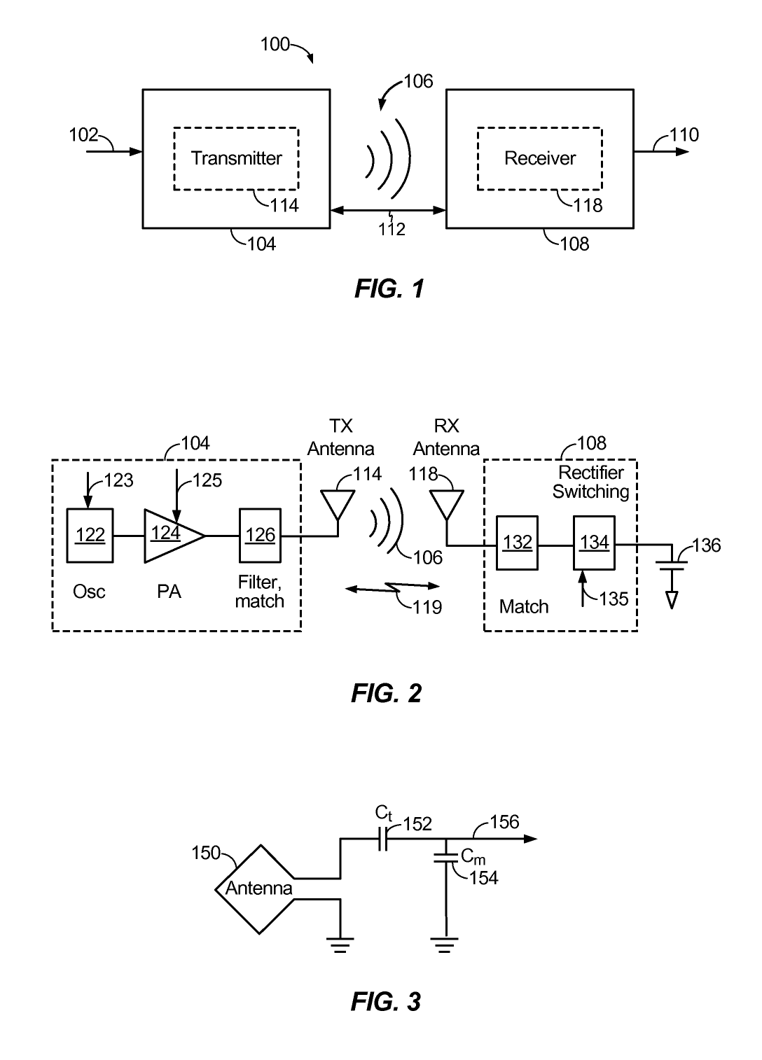

FIG. 1 illustrates a wireless transmission or charging system 100, in accordance with various exemplary embodiments of the present invention. Input power 102 is provided to a transmitter 104 for generating a radiated field 106 for providing energy transfer. A receiver 108 couples to the radiated field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the radiated field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

FIG. 2 shows a simplified schematic diagram of a wireless power transfer system.

The transmitter 104 includes an oscillator 122, a power amplifier 124 and a filter and matching circuit 126. The oscillator is configured to generate a signal at a desired frequency, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114.

The receiver 108 may include a matching circuit 132 and a rectifier and switching circuit 134 to generate a DC power output to charge a battery 136 as shown in FIG. 2 or power a device coupled to the receiver (not shown). The matching circuit 132 may be included to match the impedance of the receiver 108 to the receive antenna 118. The receiver 108 and transmitter 104 may communicate on a separate communication channel 119 (e.g., Bluetooth, zigbee, cellular, etc).

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred at a lower efficiency. Transfer of energy occurs by coupling energy from the near-field of the transmitting antenna to the receiving antenna residing in the neighborhood where this near-field is established rather than propagating the energy from the transmitting antenna into free space.

The resonant frequency of the loop or magnetic antennas is based on the inductance and capacitance. Inductance in a loop antenna is generally simply the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

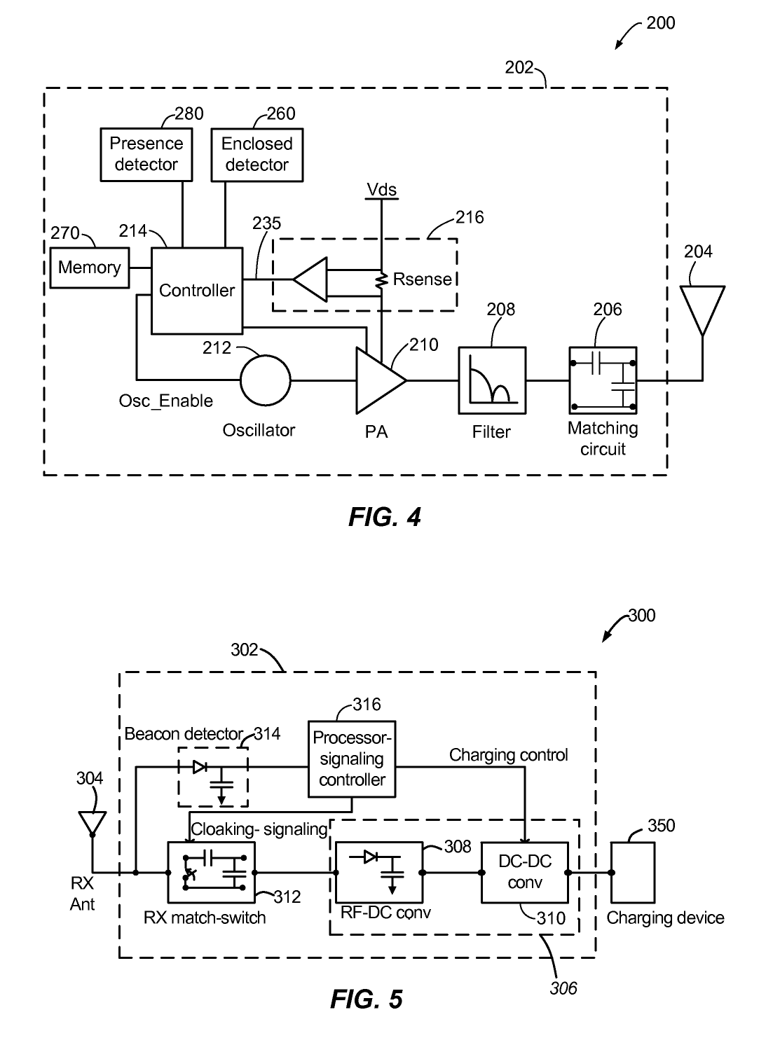

FIG. 4 is a simplified block diagram of a transmitter 200, in accordance with an exemplary embodiment of the present invention. The transmitter 200 includes transmit circuitry 202 and a transmit antenna 204. Generally, transmit circuitry 202 provides RF power to the transmit antenna 204 by providing an oscillating signal resulting in generation of near-field energy about the transmit antenna 204. By way of example, transmitter 200 may operate at the 13.56 MHz ISM band.

Exemplary transmit circuitry 202 includes a fixed impedance matching circuit 206 for matching the impedance of the transmit circuitry 202 (e.g., 50 ohms) to the transmit antenna 204 and a low pass filter (LPF) 208 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that can be varied based on measurable transmit metrics, such as output power to the antenna or DC current draw by the power amplifier. Transmit circuitry 202 further includes a power amplifier 210 configured to drive an RF signal as determined by an oscillator 212. The transmit circuitry may be comprised of discrete devices or circuits, or alternately, may be comprised of an integrated assembly. An exemplary RF power output from transmit antenna 204 may be on the order of 2.5 Watts.

Transmit circuitry 202 further includes a controller 214 for enabling the oscillator 212 during transmit phases (or duty cycles) for specific receivers, for adjusting the frequency of the oscillator, and for adjusting the output power level for implementing a communication protocol for interacting with neighboring devices through their attached receivers.

The transmit circuitry 202 may further include a load sensing circuit 216 for detecting the presence or absence of active receivers in the vicinity of the near-field generated by transmit antenna 204. By way of example, a load sensing circuit 216 monitors the current flowing to the power amplifier 210, which is affected by the presence or absence of active receivers in the vicinity of the near-field generated by transmit antenna 204. Detection of changes to the loading on the power amplifier 210 are monitored by controller 214 for use in determining whether to enable the oscillator 212 for transmitting energy to communicate with an active receiver.

Transmit antenna 204 may be implemented as an antenna strip with the thickness, width and metal type selected to keep resistive losses low. In a conventional implementation, the transmit antenna 204 can generally be configured for association with a larger structure such as a table, mat, lamp or other less portable configuration. Accordingly, the transmit antenna 204 generally will not need “turns” in order to be of a practical dimension. An exemplary implementation of a transmit antenna 204 may be “electrically small” (i.e., fraction of the wavelength) and tuned to resonate at lower usable frequencies by using capacitors to define the resonant frequency. In an exemplary application where the transmit antenna 204 may be larger in diameter, or length of side if a square loop, (e.g., 0.50 meters) relative to the receive antenna, the transmit antenna 204 will not necessarily need a large number of turns to obtain a reasonable capacitance.

The transmitter 200 may gather and track information about the whereabouts and status of receiver devices that may be associated with the transmitter 200. Thus, the transmitter circuitry 202 may include a presence detector 280, an enclosed detector 290, or a combination thereof, connected to the controller 214 (also referred to as a processor herein). The controller 214 may adjust an amount of power delivered by the amplifier 210 in response to presence signals from the presence detector 280 and the enclosed detector 290. The transmitter may receive power through a number of power sources, such as, for example, an AC-DC converter (not shown) to convert conventional AC power present in a building, a DC-DC converter (not shown) to convert a conventional DC power source to a voltage suitable for the transmitter 200, or directly from a conventional DC power source (not shown).

As a non-limiting example, the presence detector 280 may be a motion detector utilized to sense the initial presence of a device to be charged that is inserted into the coverage area of the transmitter. After detection, the transmitter may be turned on and the RF power received by the device may be used to toggle a switch on the Rx device in a pre-determined manner, which in turn results in changes to the driving point impedance of the transmitter.

As another non-limiting example, the presence detector 280 may be a detector capable of detecting a human, for example, by infrared detection, motion detection, or other suitable means. In some exemplary embodiments, there may be regulations limiting the amount of power that a transmit antenna may transmit at a specific frequency. In some cases, these regulations are meant to protect humans from electromagnetic radiation. However, there may be environments where transmit antennas are placed in areas not occupied by humans, or occupied infrequently by humans, such as, for example, garages, factory floors, shops, and the like. If these environments are free from humans, it may be permissible to increase the power output of the transmit antennas above the normal power restrictions regulations. In other words, the controller 214 may adjust the power output of the transmit antenna 204 to a regulatory level or lower in response to human presence and adjust the power output of the transmit antenna 204 to a level above the regulatory level when a human is outside a regulatory distance from the electromagnetic field of the transmit antenna 204.

As a non-limiting example, the enclosed detector 290 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 200 does not remain on indefinitely may be used. In this case, the transmitter 200 may be programmed to shut off after a user-determined amount of time. This feature prevents the transmitter 200, notably the power amplifier 210, from running long after the wireless devices in its perimeter are fully charged. This event may be due to the failure of the circuit to detect the signal sent from either the repeater or the receive coil that a device is fully charged. To prevent the transmitter 200 from automatically shutting down if another device is placed in its perimeter, the transmitter 200 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a simplified block diagram of a receiver 300, in accordance with an exemplary embodiment of the present invention. The receiver 300 includes receive circuitry 302 and a receive antenna 304. Receiver 300 further couples to device 350 for providing received power thereto. It should be noted that receiver 300 is illustrated as being external to device 350 but may be integrated into device 350. Generally, energy is propagated wirelessly to receive antenna 304 and then coupled through receive circuitry 302 to device 350.

Receive antenna 304 is tuned to resonate at the same frequency, or near the same frequency, as transmit antenna 204 (FIG. 4). Receive antenna 304 may be similarly dimensioned with transmit antenna 204 or may be differently sized based upon the dimensions of the associated device 350. By way of example, device 350 may be a portable electronic device having diametric or length dimension smaller that the diameter of length of transmit antenna 204. In such an example, receive antenna 304 may be implemented as a multi-turn antenna in order to reduce the capacitance value of a tuning capacitor (not shown) and increase the receive antenna's impedance. By way of example, receive antenna 304 may be placed around the substantial circumference of device 350 in order to maximize the antenna diameter and reduce the number of loop turns (i.e., windings) of the receive antenna and the inter-winding capacitance.

Receive circuitry 302 provides an impedance match to the receive antenna 304. Receive circuitry 302 includes power conversion circuitry 306 for converting a received RF energy source into charging power for use by device 350. Power conversion circuitry 306 includes an RF-to-DC converter 308 and may also in include a DC-to-DC converter 310. RF-to-DC converter 308 rectifies the RF energy signal received at receive antenna 304 into a non-alternating power while DC-to-DC converter 310 converts the rectified RF energy signal into an energy potential (e.g., voltage) that is compatible with device 350. Various RF-to-DC converters are contemplated, including partial and full rectifiers, regulators, bridges, doublers, as well as linear and switching converters.

Receive circuitry 302 may further include switching circuitry 312 for connecting receive antenna 304 to the power conversion circuitry 306 or alternatively for disconnecting the power conversion circuitry 306. Disconnecting receive antenna 304 from power conversion circuitry 306 not only suspends charging of device 350, but also changes the “load” as “seen” by the transmitter 200 (FIG. 2).

As disclosed above, transmitter 200 includes load sensing circuit 216 which detects fluctuations in the bias current provided to transmitter power amplifier 210. Accordingly, transmitter 200 has a mechanism for determining when receivers are present in the transmitter's near-field.

When multiple receivers 300 are present in a transmitter's near-field, it may be desirable to time-multiplex the loading and unloading of one or more receivers to enable other receivers to more efficiently couple to the transmitter. A receiver may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 300 and detected by transmitter 200 provides a communication mechanism from receiver 300 to transmitter 200 as is explained more fully below. Additionally, a protocol can be associated with the switching which enables the sending of a message from receiver 300 to transmitter 200. By way of example, a switching speed may be on the order of 100 μsec.

In an exemplary embodiment, communication between the transmitter and the receiver refers to a device sensing and charging control mechanism, rather than conventional two-way communication. In other words, the transmitter uses on/off keying of the transmitted signal to adjust whether energy is available in the near-filed. The receivers interpret these changes in energy as a message from the transmitter. From the receiver side, the receiver uses tuning and de-tuning of the receive antenna to adjust how much power is being accepted from the near-field. The transmitter can detect this difference in power used from the near-field and interpret these changes as a message from the receiver.

Receive circuitry 302 may further include signaling detector and beacon circuitry 314 used to identify received energy fluctuations, which may correspond to informational signaling from the transmitter to the receiver. Furthermore, signaling and beacon circuitry 314 may also be used to detect the transmission of a reduced RF signal energy (i.e., a beacon signal) and to rectify the reduced RF signal energy into a nominal power for awakening either un-powered or power-depleted circuits within receive circuitry 302 in order to configure receive circuitry 302 for wireless charging.

Receive circuitry 302 further includes processor 316 for coordinating the processes of receiver 300 described herein including the control of switching circuitry 312 described herein. Cloaking of receiver 300 may also occur upon the occurrence of other events including detection of an external wired charging source (e.g., wall/USB power) providing charging power to device 350. Processor 316, in addition to controlling the cloaking of the receiver, may also monitor beacon circuitry 314 to determine a beacon state and extract messages sent from the transmitter. Processor 316 may also adjust DC-to-DC converter 310 for improved performance.

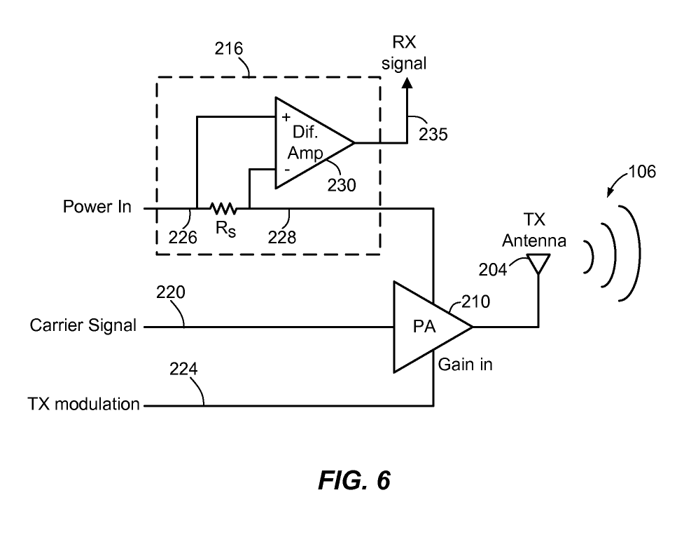

FIG. 6 shows a simplified schematic of a portion of transmit circuitry for carrying out messaging between a transmitter and a receiver. In some exemplary embodiments of the present invention, a means for communication may be enabled between the transmitter and the receiver. In FIG. 6 a power amplifier 210 drives the transmit antenna 204 to generate the radiated field. The power amplifier is driven by a carrier signal 220 that is oscillating at a desired frequency for the transmit antenna 204. A transmit modulation signal 224 is used to control the output of the power amplifier 210.

The transmit circuitry can send signals to receivers by using an ON/OFF keying process on the power amplifier 210. In other words, when the transmit modulation signal 224 is asserted, the power amplifier 210 will drive the frequency of the carrier signal 220 out on the transmit antenna 204. When the transmit modulation signal 224 is negated, the power amplifier will not drive out any frequency on the transmit antenna 204.

The transmit circuitry of FIG. 6 also includes a load sensing circuit 216 that supplies power to the power amplifier 210 and generates a receive signal 235 output. In the load sensing circuit 216 a voltage drop across resistor Rₛ develops between the power in signal 226 and the power supply 228 to the power amplifier 210. Any change in the power consumed by the power amplifier 210 will cause a change in the voltage drop that will be amplified by differential amplifier 230. When the transmit antenna is in coupled mode with a receive antenna in a receiver (not shown in FIG. 6) the amount of current drawn by the power amplifier 210 will change. In other words, if no coupled mode resonance exist for the transmit antenna 204, the power required to drive the radiated field will be a first amount. If a coupled mode resonance exists, the amount of power consumed by the power amplifier 210 will go up because much of the power is being coupled into the receive antenna. Thus, the receive signal 235 can indicate the presence of a receive antenna coupled to the transmit antenna 235 and can also detect signals sent from the receive antenna. Additionally, a change in receiver current draw will be observable in the transmitter's power amplifier current draw, and this change can be used to detect signals from the receive antennas.

Various exemplary embodiments as described herein are related to a display device having a wireless charging system integrated therein and configured to visually display data, audibly display data, or both. According to an exemplary embodiment, the display device may comprise a multi-touch display. As a more specific example, the display device may comprise a multi-touch display integrated within a table (e.g., a table within a restaurant or a library).

As described more fully below, the display device may be configured to access data stored within an electronic device, which is positioned within an associated near-field region (e.g., a positioned on a surface of the display device). For example, the display device may be configured to access, and possibly retrieve, data (e.g., audio files, data files, or video files) stored on an electronic device positioned within a near-field region. Moreover, as described below, the display device may be configured to display data (e.g., audio files, data files, or video files), which was accessed, and possibly retrieved, from the electronic device. According to one exemplary embodiment, the display device may be configured to display images, videos, graphics, alphanumeric text, or any combination thereof.

According to one exemplary embodiment, the display device may be configured to access data stored on one or more electronic devices positioned within a near-field region and which is related to an educational class (e.g., lecture slides, a class syllabus, or a lecture video). Moreover, the display device may be configured to display the accessed data (e.g., the lecture slides, the class syllabus, and/or the lecture video) on a display surface of the device. As another example, the display device may be configured to access data, which is stored on an electronic device and is related to a user. More specifically, as an example, data, related to a user, and stored on the user's electronic device, may comprise medical conditions (e.g., allergies or dietary constraints), user preferences (e.g., favorite foods, favorite drinks, or favorite sports teams), and the like. Additionally, the display device may be configured to generate and display data, which is customized according to the data related to the user. According to one exemplary embodiment, the display device, which in this embodiment may comprise a restaurant table, may be configured to access data related to a user's known allergies and food preferences and, in response thereto, may generate a virtual menu having appropriate menu items considering allergies and/or preferences of the user. Stated another way, in the context of a restaurant, display device 700 may be configured to generate and display a personalized food and beverage menu according to the user's favorite foods, favorite drinks, allergies, and/or dietary constraints.

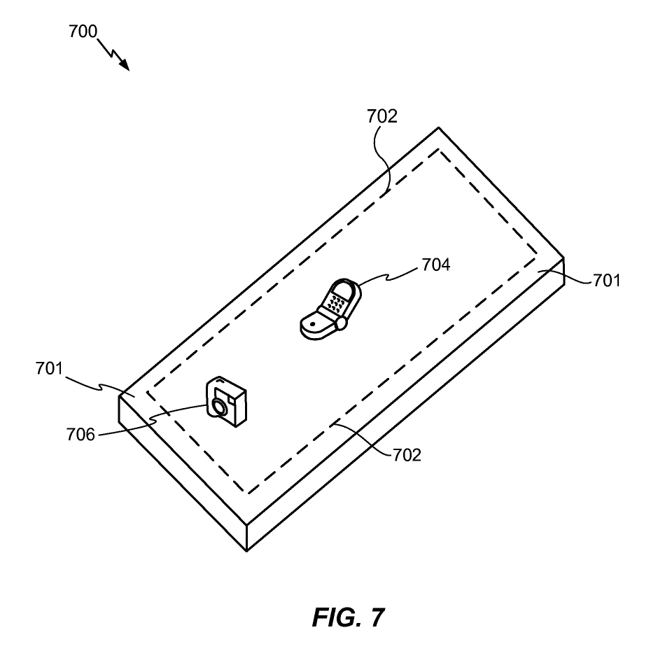

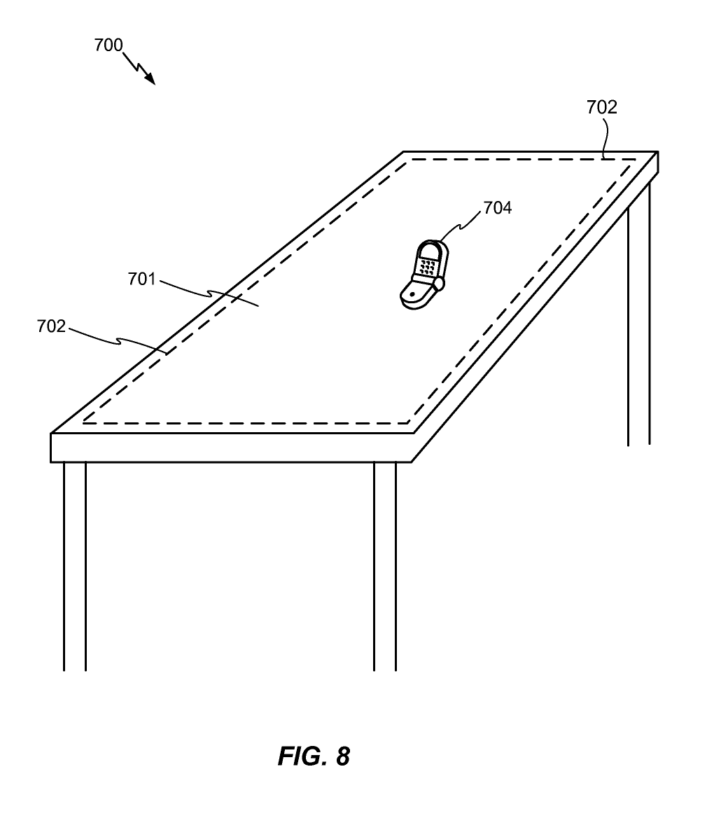

FIG. 7 illustrates a display device 700 configured for wireless charging, in accordance with various exemplary embodiments of the present invention. Display device 700 may include a display 701, which may comprise, for example only, a touch sensitive screen. In addition, device 700 may include an antenna 702 configured to wirelessly transmit power within an associated near-field region, transmit data within an associated near-field region, receive data within an associated near-field region, or any combination thereof. It is noted that display device 700 may wirelessly convey power to one or more electronic devices (e.g., mobile telephone 704 and camera 706), which are positioned within an associated near-field region, to power the one or more electronic devices, charge the one or more electronic devices, or a combination thereof. FIG. 8 is another illustration of display device 700 including antenna 702. As illustrated in FIG. 8, display device 700 may be integrated within a table.

With reference to FIGS. 7 and 8, as configured, display device 700 may detect and authenticate the presence of an electronic device (e.g., mobile telephone 704 and camera 706) positioned on a surface 701 thereof. The presence of an electronic device, for example, mobile phone 704 or digital camera 706, positioned upon surface 701 may be determined by detecting a field disturbance of a magnetic field established between antenna 702 and an antenna (not shown) within the electronic device (e.g., mobile phone 704) and configured for receiving wireless power. In addition to detecting the presence of an electronic device, a field disturbance may indicate that an electronic device is ready to receive wireless power, or ready to transmit or receive information.

Furthermore, as noted above and, in accordance with an exemplary embodiment, display device 700 may be configured to access, and possible retrieve, data from an electronic device (e.g., mobile telephone 704) positioned within an associated near-field region. More specifically, as an example, display device 700 may be configured to establish a communication link with mobile telephone 704 and, upon establishing the communication link, may access information (e.g., audio files, data files, or video files) stored on mobile telephone 704. It is noted that the communication link may be established through any known and suitable manner. For example, the communication link may be established via near-field communication (NFC) means.

Additionally, after a data link has been established and data is transferred from the electronic device to device 700, a user may interact with the data in a user-friendly, multi-touch way, while the electronic device positioned on surface 701 receives a wireless charge. As an example, data transferred from the electronic device may be conveyed (e.g., photographs may be displayed or music may be played) on surface 701 while the electronic device is charging. It is noted that a device user may access and interact with data stored on and electronic device without transferring the data from the electronic device to display device 700. It is further noted that display device 700 may enable for communication between electronic devices positioned within an associated near-field region. For example, with reference to FIG. 7, display device 700 may enable for mobile telephone 704 and camera 706 to exchange data, such as images.

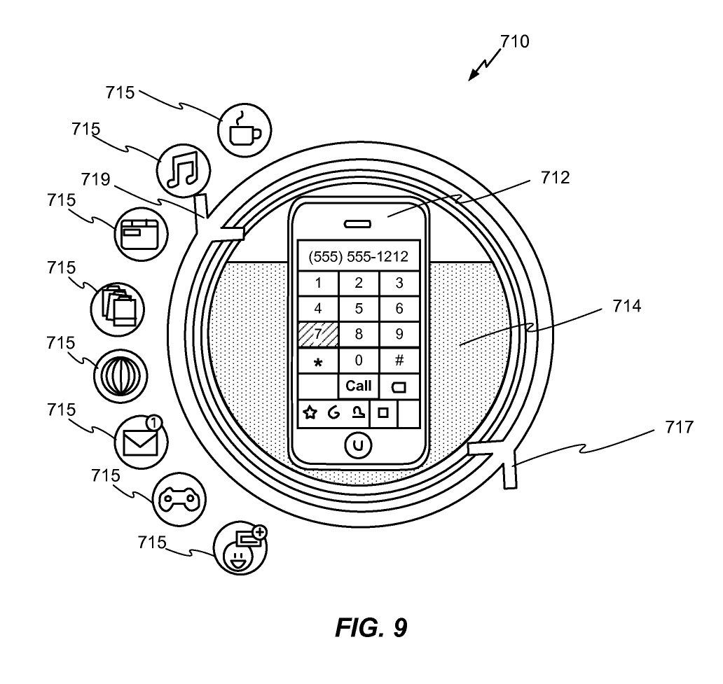

FIG. 9 depicts a portion of a display surface 710 of display device 700 (see FIGS. 7 and 8) having an electronic device 712 positioned within an associated near-field region. As noted above, display device 700 may be configured to display data relating to electronic device 712. For example, battery state information (i.e., a charging level) related to a battery of electronic device 712 may be displayed on display surface 710. More specifically, battery state information may displayed on display surface 710 as an analog representation, such as, for example only, a percentage of fill in a circle, as indicated by reference numeral 714. Furthermore, arrows 717 and 719, which are displayed on display surface 710, may be rotate (i.e., spin) around electronic device 712 to indicate that electronic device 712 is receiving a wireless charge.

With further reference to FIGS. 7-9, display device 700 may be configured to display interactive icons 715, which may enable a user to access data stored within electronic device 712, initiate an application of electronic device 712, or a combination thereof. For example, a device user may activate an email application via an icon 715 and, thereafter, may read and/or compose an email via an email application displayed on surface 701. As another example, a device user may activate an internet browser via an icon 715 and, thereafter, may browse the internet via an internet browser displayed on surface 701.

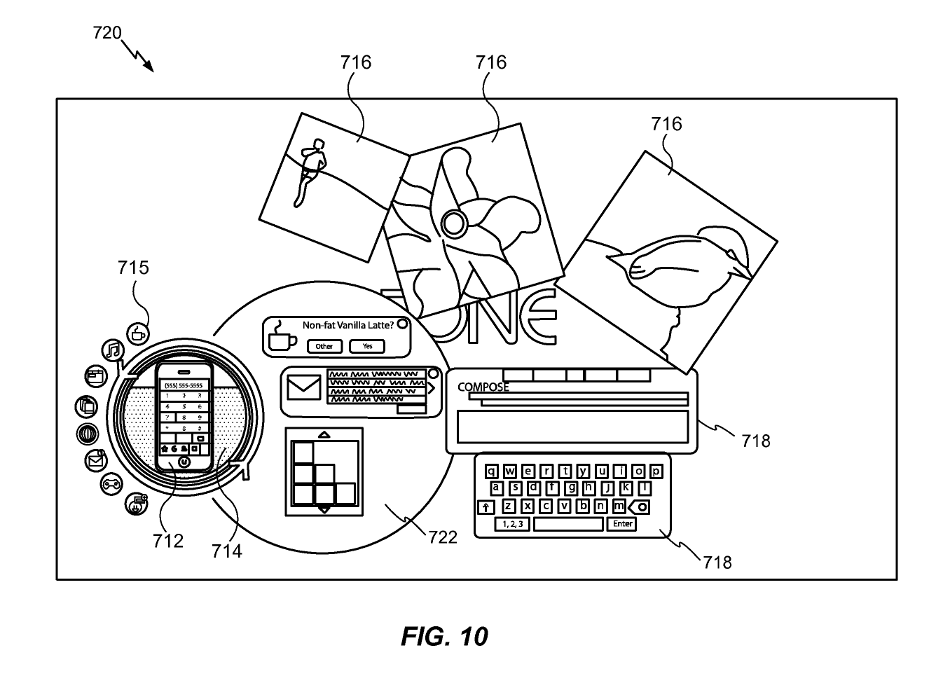

FIG. 10 illustrates a portion of a display surface 720 of display device 700 (see FIGS. 7 and 8) having an electronic device 712 positioned within an associated near-field region. With reference to FIGS. 7, 8, and 10, display device 700 may be configured to retrieve data from electronic device 712 and display the data (e.g., images 716) on display surface 720. Display device 700 may further be configured to display an interface 718, such as, for example, a QWERTY keyboard. Accordingly, display device 700 may enable a device user to use an application (e.g., email) of electronic device 712 via display surface 720. More specifically, as an example, a device user may initiate, via icon 715, an email application stored on electronic device 712 and compose and send an email via interface 718. Display device 700 may also be configured to display another interface 722 including additional information such as queries, thumbnails, emails, etc.

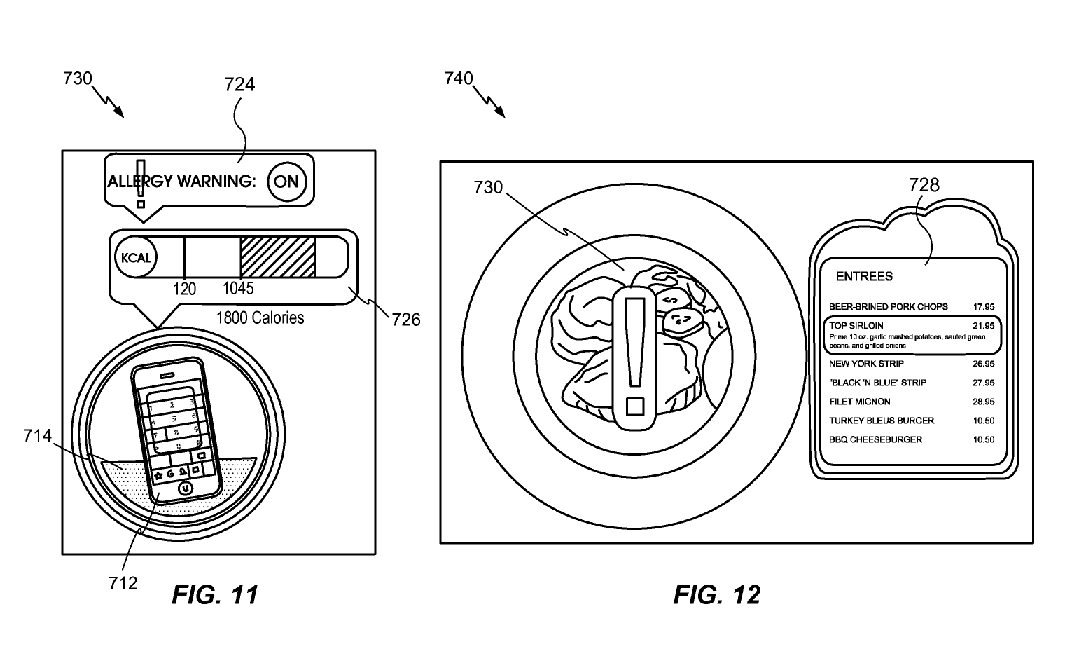

FIG. 11 depicts a portion of a display surface 730 of display device 700 (see FIGS. 7 and 8) having electronic device 712 positioned within an associated near-field region. As noted above, display device 700 may be configured to display data relating to electronic device 712. For example, battery state information (i.e., a charging level) related to a battery of electronic device 712 may be displayed on display surface 730. More specifically, battery state information may displayed on display surface 730 as an analog representation, such as, for example only, a percentage of fill in a circle, as indicated by reference numeral 714.

With reference to FIGS. 7, 8, and 11, display device 700 may be configured to access data, which is stored on electronic device 712 and which is related to a user of the electronic device. Stated another way, data stored on electronic device 712 may be communicated to display device 700. More specifically, as an example, data, related to a user, and stored on the electronic device 712, may include medical conditions (e.g., allergies or dietary constraints), user preferences (e.g., favorite foods and favorite drinks), and the like. Additionally, display device 700 may be configured to generate and display data, which is customized (e.g., personalized food and beverage menu), according to the data that is related to the user and stored on electronic device 712. According to one exemplary embodiment, display device 700, which in this embodiment may be integrated within a restaurant table, may be configured to access data related to a user's known allergies and food preferences and, in response thereto, may generate and display data, such as, for example, an allergy warning 724 or calorie content 726, on surface 730.

FIG. 12 depicts a portion of a display surface 740 of display device 700 (see FIGS. 7 and 8). With reference to FIGS. 7, 8, and 12, display device 700 may be configured to generate and display data, such as a virtual menu 728 including prices of menu items, and possibly an image 730 of a selected menu item. It is noted that the data (e.g., virtual menu 728) displayed on display surface 740 may be customized for a particular user (e.g., according to allergies, dietary constraints, and/or preferences of the user). Furthermore, a user may interact with virtual menu 728 to order one or more menu items.

Furthermore, according to one exemplary embodiment, display device 700 may be configured to, upon a device user positioning an electronic device within a near-field region, automatically order one or more menu items according to stored preferences of the user. As another example, display device 700 may facilitate a payment process (e.g., at a restaurant) by linking to a user's checking account via the user's electronic device, which is positioned within a near-field region of display device 700.

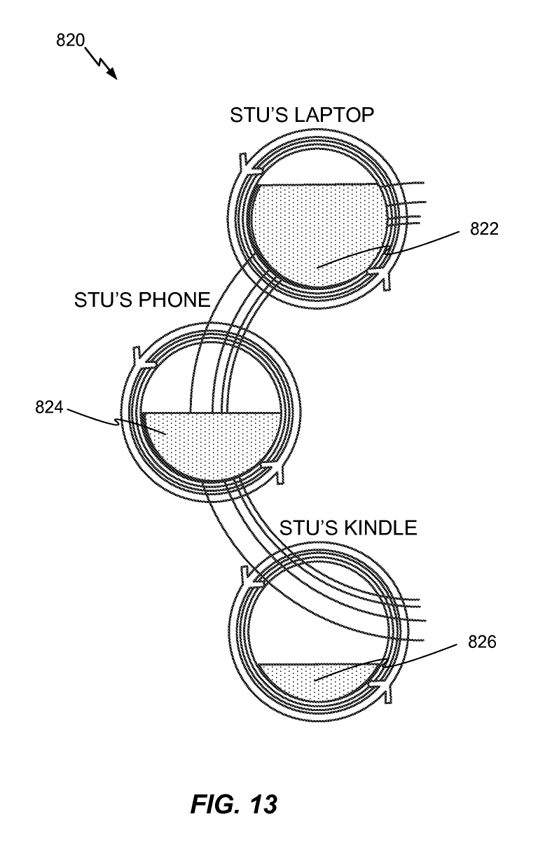

FIG. 13 depicts a portion of a display surface 820 of display device 700 (see FIGS. 7 and 8) including battery state information (i.e., a charging level) associated with a user's device positioned on display surface 820. More specifically, for example, display surface 820 may display battery state information (i.e., a charging level) associated with a battery of a device user's laptop that is positioned within an associated near-field region (indicated by reference numeral 822), a battery of the device user's mobile telephone that is positioned within an associated near-field region (indicated by reference numeral 824), and a battery of the device user's kindle that is positioned within an associated near-field region (indicated by reference numeral 826). More specifically, battery state information may displayed on display surface 820 as an analog representation, such as, for example only, a percentage of fill in a circle, as described above.

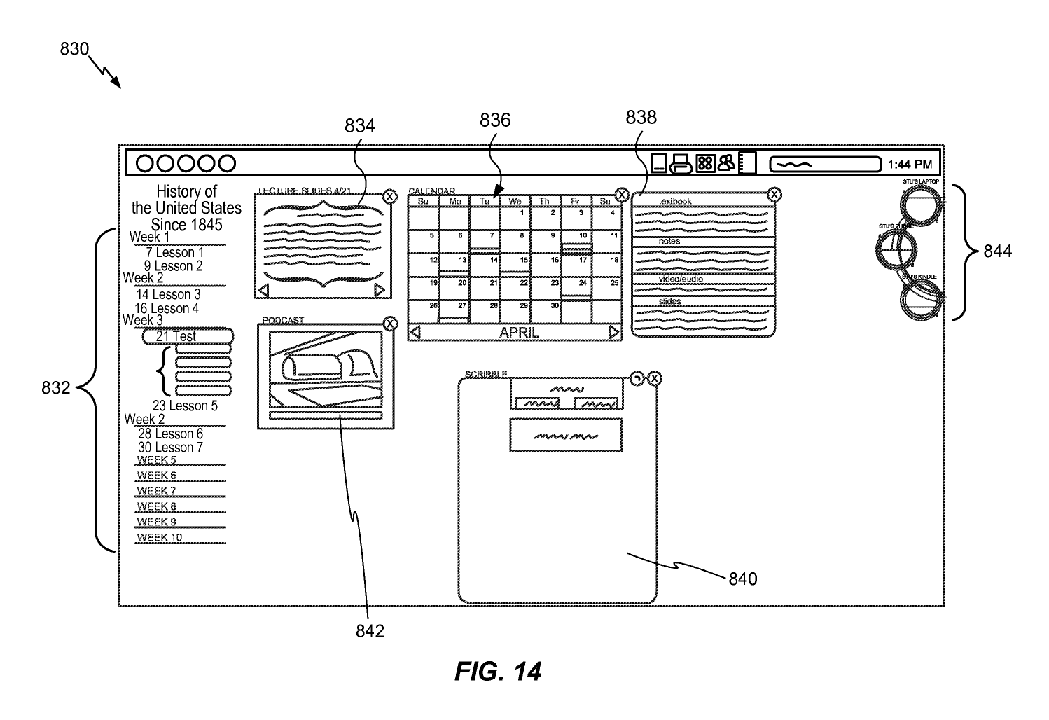

FIG. 14 illustrates at least a portion of a display surface 830 of display device 700 (see FIGS. 7 and 8) displaying data related to an education class, such as course content, including slides, video podcasts, notes, textbook, etc. As illustrated in FIG. 14, display surface 830 may be configured to display data (e.g., multi-media content), which was retrieved from one or more electronic devices positioned thereon. For example only, display surface 830 may be configured to retrieve, from one or more electronic device, and display lecture slides 834, a podcast 842, syllabus 832, and a class calendar 836. Furthermore, display surface 700 may display an area 830 (e.g., a scribble pad) configured to enable one or more device users to take notes, which may be saved onto one or more electronic devices positioned on display surface 830. As another example, display surface 700 may display additional data 838 such as information related to a class textbook, class notes, audio and/or audio related to a class, and class slides. Moreover, as noted above, display surface 820 may be configured to display battery state information 844 (i.e., a charging level) associated with one or more devices positioned thereon.

With continued reference to FIG. 14, it is noted that according to one exemplary embodiment, one or more individuals (e.g., students) positioned proximate a table (e.g., a table within a library) having display device 700 (see FIGS. 7 and 8) integrated therein, may visualize, and possible interact with data, which is related to an education class, displayed on display surface 830. It is further noted that the data related to the educational class and displayed on display surface 830 may originate from one or more electronic devices positioned thereon. Exemplary embodiments described herein enable for integration of multimedia educational course content into a mobile device, which may mitigate the problem of having to carry heavy books, laptops, etc. Display device 700 not only provides access to, and possibly manipulation of, the course content, but may also serve as a reliable power source.

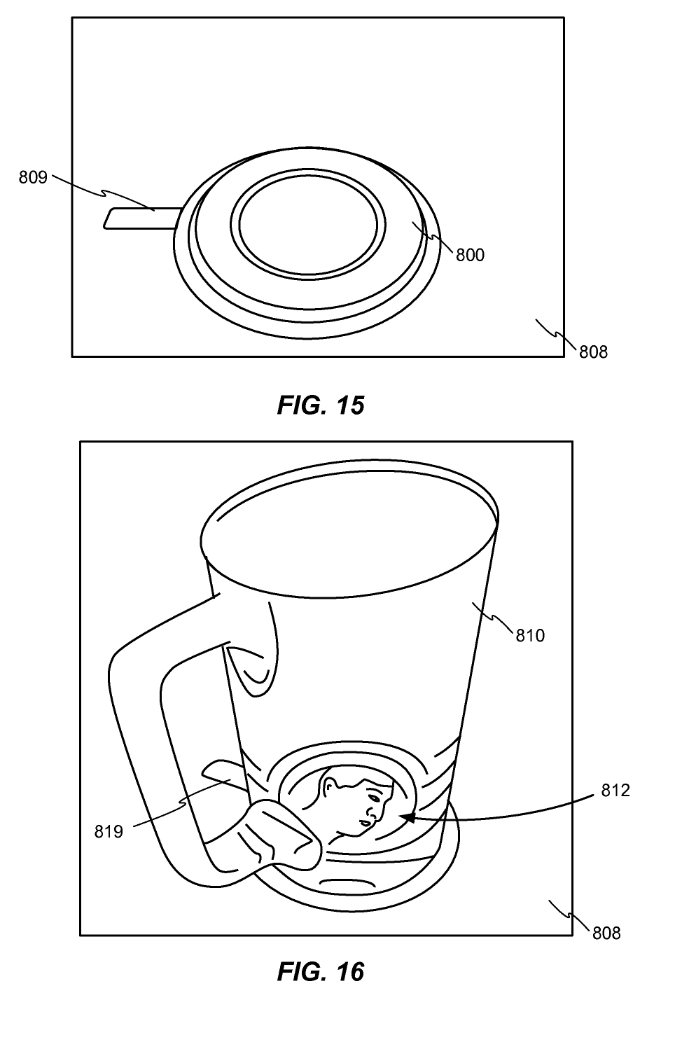

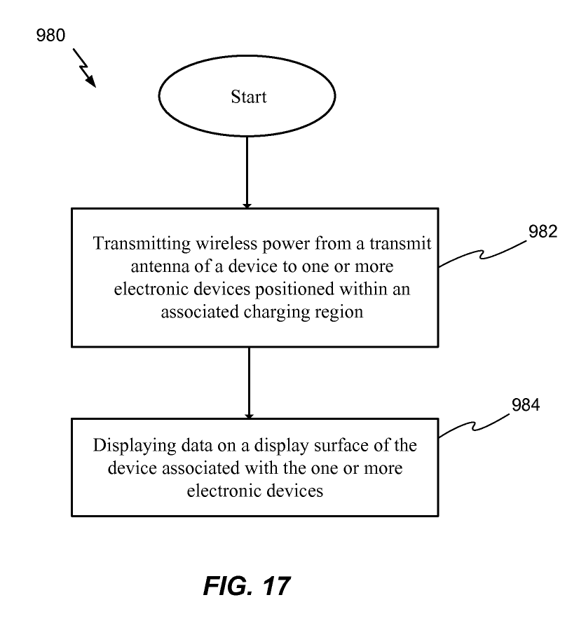

FIG. 15 illustrates a portion of a display surface 808 of display device 700 (see FIGS. 7 and 8) having a plate positioned thereon. According to one exemplary embodiment, display device 700 may be configured to convey wireless power, which may be received by plate 800. Furthermore, upon receiving wireless power, plate 800 may be configured to heat or cool itself via thermoelectric methods (i.e., Peltier effect). More specifically, for example, plate 800 may include a device (e.g., a chip) for enabling plate 800, upon receipt of wireless power, to cool or heat itself via thermoelectric methods known in the art. Display surface 808 may further include a virtual controller 809 configured to enable a device user to control a temperature of plate 800. More specifically, for example, a device user may interact with virtual controller 809 via touch to adjust a temperature of plate 800.

FIG. 16 illustrates another portion of display surface 808 of display device 700 (see FIGS. 7 and 8) having a cup 810 positioned thereon. According to one exemplary embodiment, display device 700 may be configured to convey wireless power, which may be received by cup 810. Furthermore, upon receiving wireless power, cup 810 may be configured to heat or cool itself via thermoelectric methods (i.e., Peltier effect). More specifically, for example, cup 810 may include a device (e.g., a chip) for enabling cup 810, upon receipt of wireless power, to cool or heat itself via thermoelectric methods known in the art. Display surface 808 may further include a virtual controller 819 configured to enable a device user to control a temperature of cup 810. More specifically, for example, a device user may interact with virtual controller 819 via touch to adjust a temperature of cup 810. With continued reference to FIG. 16, cup 810 may be further configured to, upon receipt of wireless power, display data (e.g., an image or a video) on a portion of cup 810. As illustrated in FIG. 16, an image 812 is displayed on a bottom portion of cup 810.

FIG. 15 is a flowchart illustrating a method 980, in accordance with one or more exemplary embodiments. Method 980 may include transmitting wireless power from a transmit antenna of a device to one or more chargeable devices positioned within an associated charging region (depicted by numeral 982). Method 980 may further include displaying data on a display surface of the device associated with the one or more chargeable devices (depicted by numeral 984).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A device, comprising:
a display surface for placement of one or more chargeable devices and for displaying data associated therewith; and
at least one transmit antenna proximate the display surface for transmitting wireless power within an associated charging region.

2. The device of claim 1, wherein the display surface is configured to at least one of visually convey data and audibly convey data.

3. The device of claim 1, wherein the device is integrated within a table.

4. The device of claim 1, wherein the display surface comprises a multi-touch display.

5. The device of claim 1, wherein the device is configured to at least one of access data on the one or more chargeable devices and retrieve data from the one or more chargeable devices.

6. The device of claim 1, wherein the device is configured to generate and display content in response to accessing data on a chargeable device positioned within an associated charging region.

7. The device of claim 1, wherein the device is configured to generate and display content personalized for a user on the display surface in response to accessing user preferences on a chargeable device of the user positioned within an associated charging region.

8. The device of claim 1, wherein the device is configured to display battery state information associated with a chargeable device positioned within an associated near-field region.

9. The device of claim 1, wherein the device is configured to display one or more interactive icons associated with an electronic device of the one or more electronic devices.

10. The device of claim 1, wherein the device is configured to display an interface on the display surface and associated with an electronic device of the one or more electronic devices.

11. The device of claim 1, wherein the device is configured to enable two or more electronic devices of the one or more electronic devices to exchange data.

12. A method, comprising:
transmitting wireless power from a transmit antenna of a device to one or more electronic devices positioned within an associated charging region; and
displaying data on a display surface of the device associated with the one or more electronic devices.

13. The method of claim 12, wherein displaying data comprises displaying at least one of an image, a video, graphics, and alphanumeric text transmitted from at least one electronic device of the one or more electronic devices on the display surface of the device.

14. The method of claim 12, further comprising exchanging data between two or more electronic devices of the one or more electronic devices.

15. The method of claim 12, wherein displaying data comprises displaying a food and beverage menu customized according to preferences of a user stored within an electronic device associated with the user and positioned within an associated near-field region.

16. The method of claim 12, wherein displaying data comprises displaying an allergy warning according to one or more allergies of a user stored within a chargeable device of associated with the user and positioned within an associated near-field region.

17. The method of claim 12, wherein displaying data comprises display data related to an educational class.

18. The method of claim 17, wherein displaying data related to an educational class comprises displaying at least one of a class syllabus, lecture slides, class notes, an electronic textbook, and a lecture video.

19. The method of claim 12, wherein displaying data comprises displaying battery state information associated with an electronic device of the one or more electronic devices.

20. The method of claim 19, wherein displaying battery state information comprises displaying an analog representation of a charging level of the electronic device.

21. The method of claim 12, wherein displaying data comprises displaying one or more interactive icons associated with an electronic device of the one or more electronic devices.

22. The method of claim 21, further comprising initiating one or more applications stored on the electronic device via the one or more interactive icons displayed on the display surface.

23. The method of claim 12, further comprising display an interface associated with an electronic device of the one or more electronic devices on the display surface.

24. A charging device, comprising:
means for transmitting wireless power from a transmit antenna of a device to one or more chargeable devices positioned within an associated charging region; and
means for displaying data on a display surface of the device associated with the one or more chargeable devices.
